(19) United States
(12) Patent Application Publication
(10) Pub. No.: US 2026/0149170 A1
(43) Pub. Date: May 28, 2026

(54) RADOME DESIGN

(71) Applicant: SAINT-GOBAIN PERFORMANCE PLASTICS CORPORATION, Malvern, PA (US)

(72) Inventors: Nicholas A. MIRABILE, Northborough, MA (US); Michael A. MONN, Cambridge, MA (US); Alexane MARGOSSIAN, West Newton, MA (US); Matthew A. YOUNGBLOOD, Kent, OH (US); David Winfield STRESING, Kent, OH (US)

(21) Appl. No.: 19/400,540

(22) Filed: Nov. 25, 2025

Related U.S. Application Data
(60) Provisional application No. 63/725,680, filed on Nov. 27, 2024.

(51) Int. Cl. H01Q 1/42

(52) U.S. Cl. CPC H01Q 1/422

(57) ABSTRACT

A radome structure may include a first syntactic foam layer, a multilayer tuning component overlying the first syntactic foam layer, a structural laminate core overlying and in contact with the multilayer tuning component, and a second syntactic foam layer overlying the structural laminate core. The multilayer tuning component may include a first tuning sublayer, and a second tuning sublayer overlying the first tuning sublayer. The first tuning sublayer may have a dielectric constant (Dₖ₁) of at least about 1 and not greater than about 3. The second tuning sublayer may have a dielectric constant (Dₖ₂) of at least about 1 and not greater than about 3.

### CROSS-REFERENCE TO RELATED APPLICATION(S)

This application claims priority under 35 U.S.C. § 119 (e) to U.S. Provisional Application No. 63/725,680, entitled “RADOME DESIGN,” by Nicholas A. MIRABILE et al., filed Nov. 27, 2024, which is incorporated herein by reference in its entirety.

### FIELD OF THE DISCLOSURE

The present disclosure relates to radome structural designs and, in particular, to radome structural designs optimized for transmission of broadband electromagnetic waves.

### BACKGROUND

Generally, microwave antennas are covered with radomes to protect the antennas from harmful weather conditions and to ensure the antenna's continuous and precise operation. Radomes can be in the form of thin wall radomes, solid wall radomes, and sandwich radomes. Thin wall radomes have a thickness typically less than 1/16 inch and may be supported using increased air pressure or using a supporting frame. Solid wall radomes are typically made of a heavier solid laminate, and sandwich radomes include a low dielectric core material sandwiched between thin inner and outer laminate layers. The core material is typically a plastic foam structure or a honeycomb structure.

Regardless of the materials used to form radomes, the radome structure generally degrades the signal strength of electromagnetic waves transmitted from the antennas through the radome. This is particularly true in regard to wideband applications (for example, Ku+Ka), which often require extensive use of expensive materials, like quartz, to achieve desirable performance. Accordingly, radomes with improved structural designs are desired.

### SUMMARY

According to a first aspect, a radome structure may include a first syntactic foam layer, a multilayer tuning component overlying the first syntactic foam layer, a structural laminate core overlying and in contact with the multilayer tuning component, and a second syntactic foam layer overlying the structural laminate core. The multilayer tuning component may include a first tuning sublayer, and a second tuning sublayer overlying the first tuning sublayer. The first tuning sublayer may have a dielectric constant (Dₖ₁) of at least about 1 and not greater than about 3. The second tuning sublayer may have a dielectric constant (Dₖ₂) of at least about 1 and not greater than about 3. The multilayer tuning component may have an average dielectric constant Dₖ₁+Dₖ₂/2 of at least about 2 and not greater than about 3, where Dₖ₁ is the dielectric constant of the first tuning sublayer, and Dₖ₂ is the dielectric constant of the second tuning sublayer.

According to another aspect, a radome structure may include a first syntactic foam layer, a multilayer tuning component overlying the first syntactic foam layer, a structural laminate core overlying and in contact with the multilayer tuning component, and a second syntactic foam layer overlying the structural laminate core. The multilayer tuning component may include a first tuning sublayer, and a second tuning sublayer overlying the first tuning sublayer. The first tuning sublayer may include a thermoplastic polymer, a thermoset polymer, or any combination thereof. The multilayer tuning component may have an average dielectric constant Dₖ₁+Dₖ₂/2 of at least about 2 and not greater than about 3, where Dₖ₁ is the dielectric constant of the first tuning sublayer, and Dₖ₂ is the dielectric constant of the second tuning sublayer.

### BRIEF DESCRIPTION OF THE DRAWINGS

Embodiments are illustrated by way of example and are not limited to the accompanying figures.

FIG. 1 includes an illustration of a radome structure according to embodiments described herein;

FIG. 2 includes an illustration of a radome structure according to embodiments described herein;

FIG. 3 includes an illustration of a radome structure according to embodiments described herein; and

FIG. 4 includes an illustration of a radome structure according to embodiments described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a radome structure that may include a first syntactic foam layer, a multilayer tuning component overlying the first syntactic foam layer, a structural laminate core overlying and in contact with the multilayer tuning component, and a second syntactic foam layer overlying the structural laminate core. The multilayer tuning component may include a first tuning sublayer, and a second tuning sublayer overlying the first tuning sublayer.

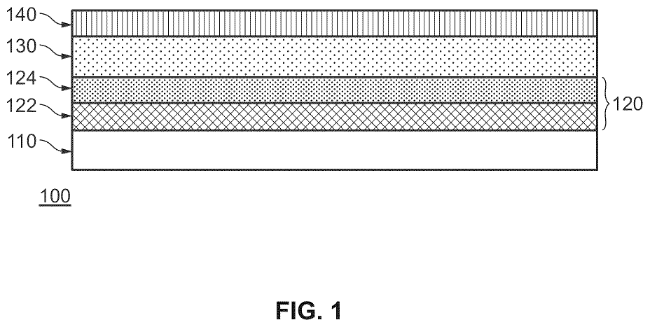

For purposes of illustration, FIG. 1 includes an illustration of a radome structure 100 according to embodiments described herein. As shown in FIG. 1, the radome structure 100 may include a first syntactic foam layer 110, a multilayer tuning component 120 overlying the first syntactic foam layer 110, a structural laminate core 130 overlying and in contact with the multilayer tuning component 120, and a second syntactic foam layer 140 overlying the structural laminate core 130. As further shown in FIG. 1, the multilayer tuning component 120 may include a first tuning sublayer 122, and a second tuning sublayer 124 overlying the first tuning sublayer 122.

Referring first to the first syntactic foam layer 110, according to certain embodiments, the first syntactic foam layer 110 may have a particular thickness. For example, the first syntactic foam layer 110 may have a thickness of at least about 0.5 mm, such as, at least about 0.6 mm or at least about 0.7 mm or at least about 0.8 mm or at least about 0.9 mm or at least about 1.0 mm or at least about 1.1 mm or at least about 1.2 mm or at least about 1.3 mm or at least about 1.4 mm or even at least about 1.5 mm. According to yet other embodiments, the first syntactic foam layer 110 may have a thickness of not greater than about 3.0 mm, such as, not greater than about 2.9 mm or not greater than about 2.8 mm or not greater than about 2.7 mm or not greater than about 2.6 mm or not greater than about 2.5 mm or not greater than about 2.4 mm or not greater than about 2.3 mm or not greater than about 2.2 mm or not greater than about 2.1 mm or even not greater than about 2.0 mm. It will be appreciated that the thickness of the first syntactic foam layer 110 may be within a range between any of the minimum and maximum values noted above. It will be further appreciated that the thickness of the first syntactic foam layer 110 may be any value between any of the minimum and maximum values noted above.

According to still other embodiments, the first syntactic foam layer 110 may have a particular dielectric constant. For example, the first syntactic foam layer 110 may have a dielectric constant of at least about 1.30, such as, at least about 1.35 or at least about 1.40 or at least about 1.45 or at least about 1.50 or at least about 1.55 or at least about 1.6 or at least about 1.65 or at least about 1.7 or even at least about 1.75. According to still other embodiments, the first syntactic foam layer 110 may have a dielectric constant of not greater than about 2.00, such as not greater than about 1.95 or not greater than about 1.90 or not greater than about 1.85 or even not greater than about 1.80. It will be appreciated that the dielectric constant of the first syntactic foam layer 110 may be within a range between any of the values noted above. It will be further appreciated that the dielectric constant of the first syntactic foam layer 110 may be any value between any of the minimum and maximum values noted above.

Referring now to the first tuning sublayer 122 of the multilayer tuning component 120, according to certain embodiments, the first tuning sublayer 122 may have a particular thickness. For example, the first tuning sublayer 122 may have a thickness of at least about 0.5 mm, such as, at least about 0.6 mm or at least about 0.7 mm or at least about 0.8 mm or at least about 0.9 mm or at least about 1.0 mm or at least about 1.1 mm or at least about 1.2 mm or at least about 1.3 mm or at least about 1.4 mm or even at least about 1.5 mm. According to yet other embodiments, the first tuning sublayer 122 may have a thickness of not greater than about 2.0 mm, such as, not greater than about 1.9 mm or not greater than about 1.8 mm or not greater than about 1.7 mm or even not greater than about 1.6 mm. It will be appreciated that the thickness of the first tuning sublayer 122 may be within a range between any of the minimum and maximum values noted above. It will be further appreciated that the thickness of the first tuning sublayer 122 may be any value between any of the minimum and maximum values noted above.

According to still other embodiments, the first tuning sublayer 122 may have a particular dielectric constant. For example, the first tuning sublayer 122 may have a dielectric constant of at least about 1.00, such as, at least about 1.05 or at least about 1.10 or at least about 1.15 or at least about 1.20 or at least about 1.25 or at least about 1.30 or at least about 1.35 or at least about 1.40 or at least about 1.45 or at least about 1.50 or at least about 1.55 or at least about 1.6 or at least about 1.65 or at least about 1.7 or even at least about 1.75. According to still other embodiments, the first tuning sublayer 122 may have a dielectric constant of not greater than about 3.00, such as not greater than about 2.90 or not greater than about 2.80 or not greater than about 2.70 or even not greater than about 2.60. It will be appreciated that the dielectric constant of the first tuning sublayer 122 may be within a range between any of the values noted above. It will be further appreciated that the dielectric constant of the first tuning sublayer 122 may be any value between any of the minimum and maximum values noted above.

According to yet other embodiments, the first tuning sublayer 122 may include a particular material. For example, the first tuning sublayer 122 may include a thermoplastic polymer. According to yet other embodiments, the first tuning sublayer 122 may consist essentially of a thermoplastic polymer. According to other embodiments, the first tuning sublayer 122 may include a thermoset polymer. According to yet other embodiments, the first tuning sublayer 122 may consist essentially of a thermoset polymer. According to other embodiments, the first tuning sublayer 122 may include a combination of a thermoplastic polymer and a thermoset polymer. According to yet other embodiments, the first tuning sublayer 122 may consist essentially of a combination of a thermoplastic polymer and a thermoset polymer.

According to yet other embodiments, where the first tuning sublayer 122 includes a thermoplastic polymer, the thermoplastic polymer may include a particular material. For example, the thermoplastic polymer may include a polyvinyl chloride (PVC). According to still other embodiments, the thermoplastic polymer may include a polyurethane (PU). According to other embodiments, the thermoplastic polymer may include a polyaryl ether ketone (PAEK). According to other embodiments, the thermoplastic polymer may include a polyether ether ketone (PEEK). According to other embodiments, the thermoplastic polymer may include a polyether ketone ketone (PEKK). According to other embodiments, the thermoplastic polymer may include a polypropylene (PP). According to other embodiments, the thermoplastic polymer may include a polycarbonate (PC). According to still other embodiments, the thermoplastic polymer may include a polyethersulfone (PESU). According to yet other embodiments, the thermoplastic polymer may include a polyphenylene sulfide (PPS). According to other embodiments, the thermoplastic polymer may include a polyamide 6 (PA6). According to still other embodiments, the thermoplastic polymer may include a polyethylene terephthalate (PET). According to yet other embodiments, the thermoplastic polymer may include a polyetherimide (PEI). According to other embodiments, the thermoplastic polymer may include any combination of a polyvinyl chloride (PVC), a polyurethane (PU), a polyaryl ether ketone (PAEK), a polyether ether ketone (PEEK), a polyether ketone ketone (PEKK), a polypropylene (PP), a polycarbonate (PC), a polyethersulfone (PESU), a polyphenylene sulfide (PPS), a polyamide 6 (PA6), a polyethylene terephthalate (PET), or a polyetherimide (PEI).

According to yet other embodiments, where the first tuning sublayer 122 consist essentially of a thermoplastic polymer, the thermoplastic polymer may consist essentially of a particular material. For example, the thermoplastic polymer may consist essentially of a polyvinyl chloride (PVC). According to still other embodiments, the thermoplastic polymer may consist essentially of a polyurethane (PU). According to other embodiments, the thermoplastic polymer may consist essentially of a polyaryl ether ketone (PAEK). According to other embodiments, the thermoplastic polymer may consist essentially of a polyether ether ketone (PEEK). According to other embodiments, the thermoplastic polymer may consist essentially of a polyether ketone ketone (PEKK). According to other embodiments, the thermoplastic polymer may consist essentially of a polypropylene (PP). According to other embodiments, the thermoplastic polymer may consist essentially of a polycarbonate (PC). According to still other embodiments, the thermoplastic polymer may consist essentially or a polyethersulfone (PESU). According to yet other embodiments, the thermoplastic polymer may consist essentially or a polyphenylene sulfide (PPS). According to other embodiments, the thermoplastic polymer may consist essentially or a polyamide 6 (PA6). According to still other embodiments, the thermoplastic polymer may consist essentially of a polyethylene terephthalate (PET). According to yet other embodiments, the thermoplastic polymer may consist essentially of a polyetherimide (PEI). According to other embodiments, the thermoplastic polymer may consist essentially of any combination of a polyvinyl chloride (PVC), a polyurethane (PU), a polyaryl ether ketone (PAEK), a polyether ether ketone (PEEK), a polyether ketone ketone (PEKK), a polypropylene (PP), a polycarbonate (PC), a polyethersulfone (PESU), a polyphenylene sulfide (PPS), a polyamide 6 (PA6), a polyethylene terephthalate (PET), or a polyetherimide (PEI).

According to yet other embodiments, where the first tuning sublayer 122 includes a thermoset polymer, the thermoset polymer may include a particular material. For example, the thermoset polymer may include an aramid (e.g., Nomex). According to still other embodiments, the thermoset polymer may include a resin. According to other embodiments, the thermoset polymer may include an epoxy resin. According to other embodiments, the thermoset polymer may include a cyanate ester resin. According to other embodiments, the thermoset polymer may include a phenolic resin. According to other embodiments, the thermoset polymer may include a polyester resin. According to yet other embodiments, the thermoset polymer may include a thermoset polyurethane. According to other embodiments, the thermoset polymer may include any combination of an aramid (e.g., Nomex), a resin, an epoxy resin, a cyanate ester resin, a phenolic resin, a polyester resin, or a thermoset polyurethane.

According to yet other embodiments, where the first tuning sublayer 122 consist essentially of a thermoset polymer, the thermoset polymer may consist essentially of a particular material. For example, the thermoset polymer may consist essentially of an aramid (e.g., Nomex). According to still other embodiments, the thermoset polymer may consist essentially of a resin. According to other embodiments, the thermoset polymer may consist essentially of an epoxy resin. According to other embodiments, the thermoset polymer may consist essentially of a cyanate ester resin. According to other embodiments, the thermoset polymer may consist essentially of a phenolic resin. According to other embodiments, the thermoset polymer may consist essentially of a polyester resin. According to yet other embodiments, the thermoset polymer may consist essentially of a thermoset polyurethane. According to other embodiments, the thermoset polymer may consist essentially of any combination of an aramid (e.g., Nomex), a resin, an epoxy resin, a cyanate ester resin, a phenolic resin, a polyester resin, or a thermoset polyurethane.

According to yet other embodiments, the first tuning sublayer 122 may have a particular structure. For example, the first tuning sublayer 122 may have a fully dense structure. According to yet other embodiments, the first tuning sublayer 122 may have a foam structure. According to still other embodiments, the first tuning sublayer 122 may have an open foam structure. According to other embodiments, the first tuning sublayer 122 may have a closed foam cell structure. According to yet other embodiments, the first tuning sublayer 122 may have a cellular structure. According to other embodiments, the first tuning sublayer 122 may have a honeycomb cellular structure. According to yet other embodiments, the first tuning sublayer 122 may have a gyroid cellular structure. According to still other embodiments, the first tuning sublayer 122 may have a lattice structure. According to other embodiments the first tuning sublayer 122 may have any combination of open cell foam structure, a closed foam cell structure, a cellular structure, a honeycomb cellular structure, a gyroid cellular structure, or a lattice structure.

Referring now to the second tuning sublayer 124 of the multilayer tuning component 120, according to certain embodiments, the second tuning sublayer 124 may have a particular thickness. For example, the second tuning sublayer 124 may have a thickness of at least about 0.5 mm, such as, at least about 0.6 mm or at least about 0.7 mm or at least about 0.8 mm or at least about 0.9 mm or at least about 1.0 mm or at least about 1.1 mm or at least about 1.2 mm or at least about 1.3 mm or at least about 1.4 mm or even at least about 1.5 mm. According to yet other embodiments, the second tuning sublayer 124 may have a thickness of not greater than about 2.0 mm, such as, not greater than about 1.9 mm or not greater than about 1.8 mm or not greater than about 1.7 mm or even not greater than about 1.6 mm. It will be appreciated that the thickness of the second tuning sublayer 124 may be within a range between any of the minimum and maximum values noted above. It will be further appreciated that the thickness of the second tuning sublayer 124 may be any value between any of the minimum and maximum values noted above.

According to still other embodiments, the second tuning sublayer 124 may have a particular dielectric constant. For example, the second tuning sublayer 124 may have a dielectric constant of at least about 1.00, such as, at least about 1.05 or at least about 1.10 or at least about 1.15 or at least about 1.20 or at least about 1.25 or at least about 1.30 or at least about 1.35 or at least about 1.40 or at least about 1.45 or at least about 1.50 or at least about 1.55 or at least about 1.6 or at least about 1.65 or at least about 1.7 or even at least about 1.75. According to still other embodiments, the second tuning sublayer 124 may have a dielectric constant of not greater than about 3.00, such as not greater than about 2.90 or not greater than about 2.80 or not greater than about 2.70 or even not greater than about 2.60. It will be appreciated that the dielectric constant of the second tuning sublayer 124 may be within a range between any of the values noted above. It will be further appreciated that the dielectric constant of the second tuning sublayer 124 may be any value between any of the minimum and maximum values noted above.

According to yet other embodiments, the second tuning sublayer 124 may include a particular material. For example, the second tuning sublayer 124 may include a thermoplastic polymer. According to yet other embodiments, the second tuning sublayer 124 may consist essentially of a thermoplastic polymer. According to other embodiments, the second tuning sublayer 124 may include a thermoset polymer. According to yet other embodiments, the second tuning sublayer 124 may consist essentially of a thermoset polymer. According to other embodiments, the second tuning sublayer 124 may include a combination of a thermoplastic polymer and a thermoset polymer. According to yet other embodiments, the second tuning sublayer 124 may consist essentially of a combination of a thermoplastic polymer and a thermoset polymer.

According to yet other embodiments, where the second tuning sublayer 124 includes a thermoplastic polymer, the thermoplastic polymer may include a particular material. For example, the thermoplastic polymer may include a polyvinyl chloride (PVC). According to still other embodiments, the thermoplastic polymer may include a polyurethane (PU). According to other embodiments, the thermoplastic polymer may include a polyaryl ether ketone (PAEK). According to other embodiments, the thermoplastic polymer may include a polyether ether ketone (PEEK). According to other embodiments, the thermoplastic polymer may include a polyether ketone ketone (PEKK). According to other embodiments, the thermoplastic polymer may include a polypropylene (PP). According to other embodiments, the thermoplastic polymer may include a polycarbonate (PC). According to still other embodiments, the thermoplastic polymer may include a polyethersulfone (PESU). According to yet other embodiments, the thermoplastic polymer may include a polyphenylene sulfide (PPS). According to other embodiments, the thermoplastic polymer may include a polyamide 6 (PA6). According to still other embodiments, the thermoplastic polymer may include a polyethylene terephthalate (PET). According to yet other embodiments, the thermoplastic polymer may include a polyetherimide (PEI). According to other embodiments, the thermoplastic polymer may include any combination of a polyvinyl chloride (PVC), a polyurethane (PU), a polyaryl ether ketone (PAEK), a polyether ether ketone (PEEK), a polyether ketone ketone (PEKK), a polypropylene (PP), a polycarbonate (PC), a polyethersulfone (PESU), a polyphenylene sulfide (PPS), a polyamide 6 (PA6), a polyethylene terephthalate (PET), or a polyetherimide (PEI).

According to yet other embodiments, where the second tuning sublayer 124 consist essentially of a thermoplastic polymer, the thermoplastic polymer may consist essentially of a particular material. For example, the thermoplastic polymer may consist essentially of a polyvinyl chloride (PVC). According to still other embodiments, the thermoplastic polymer may consist essentially of a polyurethane (PU). According to other embodiments, the thermoplastic polymer may consist essentially of a polyaryl ether ketone (PAEK). According to other embodiments, the thermoplastic polymer may consist essentially of a polyether ether ketone (PEEK). According to other embodiments, the thermoplastic polymer may consist essentially of a polyether ketone ketone (PEKK). According to other embodiments, the thermoplastic polymer may consist essentially of a polypropylene (PP). According to other embodiments, the thermoplastic polymer may consist essentially of a polycarbonate (PC). According to still other embodiments, the thermoplastic polymer may consist essentially or a polyethersulfone (PESU). According to yet other embodiments, the thermoplastic polymer may consist essentially or a polyphenylene sulfide (PPS). According to other embodiments, the thermoplastic polymer may consist essentially or a polyamide 6 (PA6). According to still other embodiments, the thermoplastic polymer may consist essentially of a polyethylene terephthalate (PET). According to yet other embodiments, the thermoplastic polymer may consist essentially of a polyetherimide (PEI). According to other embodiments, the thermoplastic polymer may consist essentially of any combination of a polyvinyl chloride (PVC), a polyurethane (PU), a polyaryl ether ketone (PAEK), a polyether ether ketone (PEEK), a polyether ketone ketone (PEKK), a polypropylene (PP), a polycarbonate (PC), a polyethersulfone (PESU), a polyphenylene sulfide (PPS), a polyamide 6 (PA6), a polyethylene terephthalate (PET), or a polyetherimide (PEI).

According to yet other embodiments, where the second tuning sublayer 124 includes a thermoset polymer, the thermoset polymer may include a particular material. For example, the thermoset polymer may include an aramid (e.g., Nomex). According to still other embodiments, the thermoset polymer may include a resin. According to other embodiments, the thermoset polymer may include an epoxy resin. According to other embodiments, the thermoset polymer may include a cyanate ester resin. According to other embodiments, the thermoset polymer may include a phenolic resin. According to other embodiments, the thermoset polymer may include a polyester resin. According to yet other embodiments, the thermoset polymer may include a thermoset polyurethane. According to other embodiments, the thermoset polymer may include any combination of an aramid (e.g., Nomex), a resin, an epoxy resin, a cyanate ester resin, a phenolic resin, a polyester resin, or a thermoset polyurethane.

According to yet other embodiments, where the second tuning sublayer 124 consist essentially of a thermoset polymer, the thermoset polymer may consist essentially of a particular material. For example, the thermoset polymer may consist essentially of an aramid (e.g., Nomex). According to still other embodiments, the thermoset polymer may consist essentially of a resin. According to other embodiments, the thermoset polymer may consist essentially of an epoxy resin. According to other embodiments, the thermoset polymer may consist essentially of a cyanate ester resin. According to other embodiments, the thermoset polymer may consist essentially of a phenolic resin. According to other embodiments, the thermoset polymer may consist essentially of a polyester resin. According to yet other embodiments, the thermoset polymer may consist essentially of a thermoset polyurethane. According to other embodiments, the thermoset polymer may consist essentially of any combination of an aramid (e.g., Nomex), a resin, an epoxy resin, a cyanate ester resin, a phenolic resin, a polyester resin, or a thermoset polyurethane.

According to yet other embodiments, the second tuning sublayer 124 may have a particular structure. For example, the second tuning sublayer 124 may have a fully dense structure. According to yet other embodiments, the second tuning sublayer 124 may have a foam structure. According to still other embodiments, the second tuning sublayer 124 may have an open foam structure. According to other embodiments, the second tuning sublayer 124 may have a closed foam cell structure. According to yet other embodiments, the second tuning sublayer 124 may have a syntactic foam structure. According to yet other embodiments, the second tuning sublayer 124 may have a cellular structure. According to other embodiments, the second tuning sublayer 124 may have a honeycomb cellular structure. According to yet other embodiments, the second tuning sublayer 124 may have a gyroid cellular structure. According to still other embodiments, the second tuning sublayer 124 may have a lattice structure. According to other embodiments the second tuning sublayer 124 may have any combination of open cell foam structure, a closed foam cell structure, a syntactic foam structure, a cellular structure, a honeycomb cellular structure, a gyroid cellular structure, or a lattice structure.

Referring now to the multilayer tuning component 120, according to certain embodiments, the multilayer tuning component 120 may have a particular thickness. For example, the multilayer tuning component 120 may have a thickness of at least about 0.5 mm, such as, at least about 0.6 mm or at least about 0.7 mm or at least about 0.8 mm or at least about 0.9 mm or at least about 1.0 mm or at least about 1.1 mm or at least about 1.2 mm or at least about 1.3 mm or at least about 1.4 mm or even at least about 1.5 mm. According to yet other embodiments, the multilayer tuning component 120 may have a thickness of not greater than about 3.0 mm, such as, not greater than about 2.9 mm or not greater than about 2.8 mm or not greater than about 2.7 mm or not greater than about 2.6 mm or not greater than about 2.5 mm or not greater than about 2.4 mm or not greater than about 2.3 mm or not greater than about 2.2 mm or not greater than about 2.1 mm or even not greater than about 2.0 mm. It will be appreciated that the thickness of the multilayer tuning component 120 may be within a range between any of the minimum and maximum values noted above. It will be further appreciated that the thickness of the multilayer tuning component 120 may be any value between any of the minimum and maximum values noted above.

Referring now to the second syntactic foam layer 140, according to certain embodiments, the second syntactic foam layer 140 may have a particular thickness. For example, the second syntactic foam layer 140 may have a thickness of at least about 0.5 mm, such as, at least about 0.6 mm or at least about 0.7 mm or at least about 0.8 mm or at least about 0.9 mm or at least about 1.0 mm or at least about 1.1 mm or at least about 1.2 mm or at least about 1.3 mm or at least about 1.4 mm or even at least about 1.5 mm. According to yet other embodiments, the second syntactic foam layer 140 may have a thickness of not greater than about 3.0 mm, such as, not greater than about 2.9 mm or not greater than about 2.8 mm or not greater than about 2.7 mm or not greater than about 2.6 mm or not greater than about 2.5 mm or not greater than about 2.4 mm or not greater than about 2.3 mm or not greater than about 2.2 mm or not greater than about 2.1 mm or even not greater than about 2.0 mm. It will be appreciated that the thickness of the second syntactic foam layer 140 may be within a range between any of the minimum and maximum values noted above. It will be further appreciated that the thickness of the second syntactic foam layer 140 may be any value between any of the minimum and maximum values noted above.

According to still other embodiments, the second syntactic foam layer 140 may have a particular dielectric constant. For example, the second syntactic foam layer 140 may have a dielectric constant of at least about 1.30, such as, at least about 1.35 or at least about 1.40 or at least about 1.45 or at least about 1.50 or at least about 1.55 or at least about 1.6 or at least about 1.65 or at least about 1.7 or even at least about 1.75. According to still other embodiments, the second syntactic foam layer 140 may have a dielectric constant of not greater than about 2.00, such as not greater than about 1.95 or not greater than about 1.90 or not greater than about 1.85 or even not greater than about 1.80. It will be appreciated that the dielectric constant of the second syntactic foam layer 140 may be within a range between any of the values noted above. It will be further appreciated that the dielectric constant of the second syntactic foam layer 140 may be any value between any of the minimum and maximum values noted above.

Referring now to the radome structure 100, according to certain embodiments, the radome structure 100 may have a particular thickness. For example, the radome structure 100 may have a thickness of at least about 3.0 mm, such as, at least about 4.0 mm or at least about 5.0 mm or at least about 10 mm or at least about 25 mm or even at least about 50 mm. According to yet other embodiments, the radome structure 100 may have a thickness of not greater than about 100 mm, such as, not greater than about 90 mm or not greater than about 80 mm or not greater than about 70 mm or even not greater than about 60 mm. It will be appreciated that the thickness of the radome structure 100 may be within a range between any of the minimum and maximum values noted above. It will be further appreciated that the thickness of the radome structure 100 may be any value between any of the minimum and maximum values noted above.

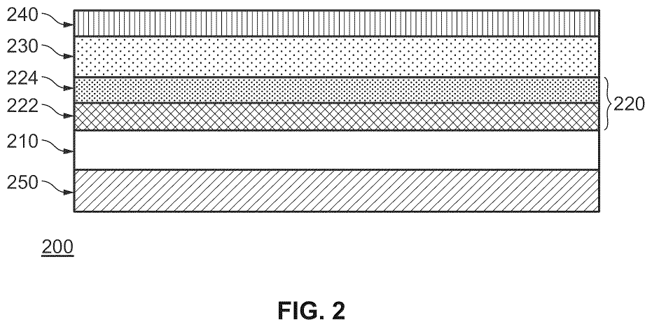

For purposes of further illustration, FIG. 2 includes an illustration of a radome structure 200 according to an alternative embodiment described herein. According to certain embodiments, and as shown in FIG. 2, the radome structure 200 may include a first syntactic foam layer 210, a multilayer tuning component 220 overlying the first syntactic foam layer 210, a structural laminate core 230 overlying and in contact with the multilayer tuning component 220, a second syntactic foam layer 240 overlying the structural laminate core 230, and a first protective layer 250 underlying the first syntactic foam layer 210. As further shown in FIG. 2, the multilayer tuning component 220 may include a first tuning sublayer 222, and a second tuning sublayer 224 overlying the first tuning sublayer 222.

For purposes of embodiments described herein, it will be appreciated that the radome structure 200, the foam layer 210, the multilayer tuning component 220, the structural laminate core 230, the second syntactic foam layer 240, the first tuning sublayer 222, and the second tuning sublayer 224 may have the same characteristics and performance of the corresponding layers in the radome structure 100.

Referring now to the first protective layer 250, according to certain embodiments, the first protective layer 250 may have a particular thickness. For example, the first protective layer 250 may have a thickness of at least about 0.05 mm, such as, at least about 0.06 mm or at least about 0.07 mm or at least about 0.08 mm or at least about 0.09 mm or at least about 0.10 mm or at least about 0.11 mm or at least about 0.12 mm or at least about 0.13 mm or at least about 0.14 mm or even at least about 0.15 mm. According to yet other embodiments, the first protective layer 250 may have a thickness of not greater than about 0.40 mm, such as, not greater than about 0.39 mm or not greater than about 0.38 mm or not greater than about 0.37 mm or not greater than about 0.36 mm or not greater than about 0.35 mm or not greater than about 0.34 mm or not greater than about 0.33 mm or not greater than about 0.32 mm or not greater than about 0.31 mm or not greater than about 0.30 mm or not greater than about 0.29 mm or not greater than about 0.28 mm or not greater than about 0.27 mm or even not greater than about 0.26 mm. It will be appreciated that the thickness of the first protective layer 250 may be within a range between any of the minimum and maximum values noted above. It will be further appreciated that the thickness of the first protective layer 250 may be any value between any of the minimum and maximum values noted above.

According to still other embodiments, the first protective layer 250 may have a particular dielectric constant. For example, the first protective layer 250 may have a dielectric constant of at least about 2.50, such as, at least about 2.55 or at least about 2.60 or at least about 2.65 or at least about 2.70 or even at least about 2.75. According to still other embodiments, the first protective layer 250 may have a dielectric constant of not greater than about 3.00, such as not greater than about 2.95 or not greater than about 2.90 or not greater than about 2.85 or even not greater than about 2.80. It will be appreciated that the dielectric constant of the first protective layer 250 may be within a range between any of the values noted above. It will be further appreciated that the dielectric constant of the first protective layer 250 may be any value between any of the minimum and maximum values noted above.

According to yet other embodiments, the first protective layer 250 may include a particular material. For example, the first protective layer 250 may include a resin. According to other embodiments, the first protective layer 250 may include an epoxy resin. According to other embodiments, the first protective layer 250 may include a cyanate ester resin. According to other embodiments, the first protective layer 250 may include a phenolic resin. According to other embodiments, the first protective layer 250 may include a polyester resin. According to other embodiments, the first protective layer 250 may include a thermoset polyurethane. According to other embodiments, the first protective layer 250 may include any combination of a resin, an epoxy resin, a cyanate ester resin, a phenolic resin, polyester resin, or a thermoset polyurethane.

According to yet other embodiments, the first protective layer 250 may include a thermoplastic polymer. According to yet other embodiments, where the first protective layer 250 includes a thermoplastic polymer, the thermoplastic polymer may include a particular material. For example, the thermoplastic polymer may include a polyvinyl chloride (PVC). According to still other embodiments, the thermoplastic polymer may include a polyurethane (PU). According to other embodiments, the thermoplastic polymer may include a polyaryl ether ketone (PAEK). According to other embodiments, the thermoplastic polymer may include a polyether ether ketone (PEEK). According to other embodiments, the thermoplastic polymer may include a polyether ketone ketone (PEKK). According to other embodiments, the thermoplastic polymer may include a polypropylene (PP). According to other embodiments, the thermoplastic polymer may include a polycarbonate (PC). According to still other embodiments, the thermoplastic polymer may include a polyethersulfone (PESU). According to yet other embodiments, the thermoplastic polymer may include a polyphenylene sulfide (PPS). According to other embodiments, the thermoplastic polymer may include a polyamide 6 (PA6). According to still other embodiments, the thermoplastic polymer may include a polyethylene terephthalate (PET). According to yet other embodiments, the thermoplastic polymer may include a polyetherimide (PEI). According to other embodiments, the thermoplastic polymer may include any combination of a polyvinyl chloride (PVC), a polyurethane (PU), a polyaryl ether ketone (PAEK), a polyether ether ketone (PEEK), a polyether ketone ketone (PEKK), a polypropylene (PP), a polycarbonate (PC), a polyethersulfone (PESU), a polyphenylene sulfide (PPS), a polyamide 6 (PA6), a polyethylene terephthalate (PET), or a polyetherimide (PEI).

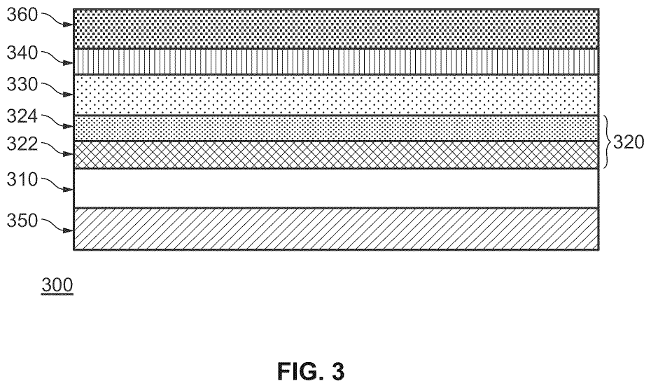

For purposes of further illustration, FIG. 3 includes an illustration of a radome structure 300 according to an alternative embodiment described herein. According to certain embodiments, and as shown in FIG. 3, the radome structure 300 may include a first syntactic foam layer 310, a multilayer tuning component 320 overlying the first syntactic foam layer 310, a structural laminate core 330 overlying and in contact with the multilayer tuning component 320, a second syntactic foam layer 340 overlying the structural laminate core 330, a first protective layer 350 underlying the first syntactic foam layer 310, and a second protective layer 360 overlying the second syntactic foam layer 340. As further shown in FIG. 3, the multilayer tuning component 320 may include a first tuning sublayer 322, and a second tuning sublayer 324 overlying the first tuning sublayer 322.

For purposes of embodiments described herein, it will be appreciated that the radome structure 300, the foam layer 310, the multilayer tuning component 320, the structural laminate core 330, the second syntactic foam layer 340, the first tuning sublayer 322, the second tuning sublayer 324, and the first protective layer 350 may have the same characteristics and performance of the corresponding layers in the radome structures 100 and/or 200.

Referring now to the second protective layer 360, according to certain embodiments, the second protective layer 360 may have a particular thickness. For example, the second protective layer 360 may have a thickness of at least about 0.05 mm, such as, at least about 0.06 mm or at least about 0.07 mm or at least about 0.08 mm or at least about 0.09 mm or at least about 0.10 mm or at least about 0.11 mm or at least about 0.12 mm or at least about 0.13 mm or at least about 0.14 mm or even at least about 0.15 mm. According to yet other embodiments, the second protective layer 360 may have a thickness of not greater than about 0.80 mm, such as, not greater than about 0.79 mm or not greater than about 0.78 mm or not greater than about 0.77 mm or not greater than about 0.76 mm or not greater than about 0.75 mm or not greater than about 0.74 mm or not greater than about 0.73 mm or not greater than about 0.72 mm or not greater than about 0.71 mm or not greater than about 0.70 mm or not greater than about 0.68 mm or not greater than about 0.67 mm or even not greater than about 0.66 mm. It will be appreciated that the thickness of the second protective layer 360 may be within a range between any of the minimum and maximum values noted above. It will be further appreciated that the thickness of the second protective layer 360 may be any value between any of the minimum and maximum values noted above.

According to still other embodiments, the second protective layer 360 may have a particular dielectric constant. For example, the second protective layer 360 may have a dielectric constant of at least about 2.50, such as, at least about 2.55 or at least about 2.60 or at least about 2.65 or at least about 2.70 or even at least about 2.75. According to still other embodiments, the second protective layer 360 may have a dielectric constant of not greater than about 4.00, such as not greater than about 3.95 or not greater than about 3.90 or not greater than about 3.85 or even not greater than about 3.80. It will be appreciated that the dielectric constant of the second protective layer 360 may be within a range between any of the values noted above. It will be further appreciated that the dielectric constant of the second protective layer 360 may be any value between any of the minimum and maximum values noted above.

According to yet other embodiments, the second protective layer 360 may include a particular material. For example, the second protective layer 360 may include a resin. According to other embodiments, the second protective layer 360 may include an epoxy resin. According to other embodiments, the second protective layer 360 may include a cyanate ester resin. According to other embodiments, the second protective layer 360 may include a phenolic resin. According to other embodiments, the second protective layer 360 may include a polyester resin. According to other embodiments, the second protective layer 360 may include a thermoset polyurethane. According to other embodiments, the second protective layer 360 may include any combination of a resin, an epoxy resin, a cyanate ester resin, a phenolic resin, polyester resin, or a thermoset polyurethane.

According to yet other embodiments, the second protective layer 360 may include a particular material. For example, the second protective layer 360 may include a low dielectric constant fiber reinforced resin material. According to other embodiments, the second protective layer 360 may include a quartz-epoxy material. According to other embodiments, the second protective layer 360 may include a quartz-cyanate ester material. According to other embodiments, the second protective layer 360 may include any combination of a quartz-epoxy material, a quartz-cyanate ester material, or any combination thereof.

According to yet other embodiments, the second protective layer 360 may include a thermoplastic polymer. According to yet other embodiments, where the second protective layer 360 includes a thermoplastic polymer, the thermoplastic polymer may include a particular material. For example, the thermoplastic polymer may include a polyvinyl chloride (PVC). According to still other embodiments, the thermoplastic polymer may include a polyurethane (PU). According to other embodiments, the thermoplastic polymer may include a polyaryl ether ketone (PAEK). According to other embodiments, the thermoplastic polymer may include a polyether ether ketone (PEEK). According to other embodiments, the thermoplastic polymer may include a polyether ketone ketone (PEKK). According to other embodiments, the thermoplastic polymer may include a polypropylene (PP). According to other embodiments, the thermoplastic polymer may include a polycarbonate (PC). According to still other embodiments, the thermoplastic polymer may include a polyethersulfone (PESU). According to yet other embodiments, the thermoplastic polymer may include a polyphenylene sulfide (PPS). According to other embodiments, the thermoplastic polymer may include a polyamide 6 (PA6). According to still other embodiments, the thermoplastic polymer may include a polyethylene terephthalate (PET). According to yet other embodiments, the thermoplastic polymer may include a polyetherimide (PEI). According to other embodiments, the thermoplastic polymer may include any combination of a polyvinyl chloride (PVC), a polyurethane (PU), a polyaryl ether ketone (PAEK), a polyether ether ketone (PEEK), a polyether ketone ketone (PEKK), a polypropylene (PP), a polycarbonate (PC), a polyethersulfone (PESU), a polyphenylene sulfide (PPS), a polyamide 6 (PA6), a polyethylene terephthalate (PET), or a polyetherimide (PEI).

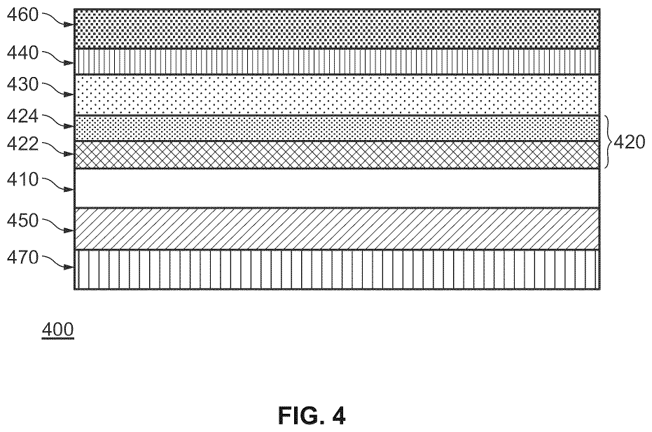

For purposes of further illustration, FIG. 4 includes an illustration of a radome structure 400 according to an alternative embodiment described herein. According to certain embodiments, and as shown in FIG. 4, the radome structure 400 may include a first syntactic foam layer 410, a multilayer tuning component 420 overlying the first syntactic foam layer 410, a structural laminate core 430 overlying and in contact with the multilayer tuning component 420, a second syntactic foam layer 440 overlying the structural laminate core 430, a first protective layer 450 underlying the first syntactic foam layer 410, a second protective layer 460 overlying the second syntactic foam layer 440, and a low dielectric constant layer 470 underlying the first protective layer 450. As further shown in FIG. 4, the multilayer tuning component 420 may include a first tuning sublayer 422, and a second tuning sublayer 424 overlying the first tuning sublayer 422.

For purposes of embodiments described herein, it will be appreciated that the radome structure 400, the foam layer 410, the multilayer tuning component 420, the structural laminate core 430, the second syntactic foam layer 440, the first tuning sublayer 422, the second tuning sublayer 424, the first protective layer 450, and the second protective layer 460 may have the same characteristics and performance of the corresponding layers in the radome structures 100, 200 and/or 300.

Referring now to the low dielectric constant layer 470, according to certain embodiments, the low dielectric constant layer 470 may have a particular thickness. For example, the low dielectric constant layer 470 may have a thickness of at least about 0.1 mm, such as, at least about 0.2 mm or at least about 0.3 mm or at least about 0.4 mm or at least about 0.5 mm or at least about 0.6 mm or at least about 0.7 mm or at least about 0.8 mm or at least about 0.9 mm or at least about 1.0 mm or at least about 1.1 mm or at least about 1.2 mm or at least about 1.3 mm or at least about 1.4 mm or even at least about 1.5 mm. According to yet other embodiments, the low dielectric constant layer 470 may have a thickness of not greater than about 3.0 mm, such as, not greater than about 2.9 mm or not greater than about 2.8 mm or not greater than about 2.7 mm or even not greater than about 2.6 mm. It will be appreciated that the thickness of the low dielectric constant layer 470 may be within a range between any of the minimum and maximum values noted above. It will be further appreciated that the thickness of the low dielectric constant layer 470 may be any value between any of the minimum and maximum values noted above.

According to still other embodiments, the low dielectric constant layer 470 may have a particular dielectric constant. For example, the low dielectric constant layer 470 may have a dielectric constant of at least about 1.00, such as, at least about 1.05 or at least about 1.10 or at least about 1.15 or at least about 1.20 or at least about 1.25 or at least about 1.30 or at least about 1.35 or at least about 1.40 or at least about 1.45 or even at least about 1.50. According to still other embodiments, the low dielectric constant layer 470 may have a dielectric constant of not greater than about 1.60, such as not greater than about 1.59 or not greater than about 1.58 or not greater than about 1.57 or even not greater than about 1.56. It will be appreciated that the dielectric constant of the low dielectric constant layer 470 may be within a range between any of the values noted above. It will be further appreciated that the dielectric constant of the low dielectric constant layer 470 may be any value between any of the minimum and maximum values noted above.

According to yet other embodiments, the low dielectric constant layer 470 may include a particular material. For example, the low dielectric constant layer 470 may include a thermoplastic polymer. According to yet other embodiments, the low dielectric constant layer 470 may consist essentially of a thermoplastic polymer. According to other embodiments, the low dielectric constant layer 470 may include a thermoset polymer. According to yet other embodiments, the low dielectric constant layer 470 may consist essentially of a thermoset polymer. According to other embodiments, the low dielectric constant layer 470 may include a combination of a thermoplastic polymer and a thermoset polymer. According to yet other embodiments, the low dielectric constant layer 470 may consist essentially of a combination of a thermoplastic polymer and a thermoset polymer.

According to yet other embodiments, where the low dielectric constant layer 470 includes a thermoplastic polymer, the thermoplastic polymer may include a particular material. For example, the thermoplastic polymer may include a polyvinyl chloride (PVC). According to still other embodiments, the thermoplastic polymer may include a polyurethane (PU). According to other embodiments, the thermoplastic polymer may include a polyaryl ether ketone (PAEK). According to other embodiments, the thermoplastic polymer may include a polyether ether ketone (PEEK). According to other embodiments, the thermoplastic polymer may include a polyether ketone ketone (PEKK). According to other embodiments, the thermoplastic polymer may include a polypropylene (PP). According to other embodiments, the thermoplastic polymer may include a polycarbonate (PC). According to still other embodiments, the thermoplastic polymer may include a polyethersulfone (PESU). According to yet other embodiments, the thermoplastic polymer may include a polyphenylene sulfide (PPS). According to other embodiments, the thermoplastic polymer may include a polyamide 6 (PA6). According to still other embodiments, the thermoplastic polymer may include a polyethylene terephthalate (PET). According to yet other embodiments, the thermoplastic polymer may include a polyetherimide (PEI). According to other embodiments, the thermoplastic polymer may include any combination of a polyvinyl chloride (PVC), a polyurethane (PU), a polyaryl ether ketone (PAEK), a polyether ether ketone (PEEK), a polyether ketone ketone (PEKK), a polypropylene (PP), a polycarbonate (PC), a polyethersulfone (PESU), a polyphenylene sulfide (PPS), a polyamide 6 (PA6), a polyethylene terephthalate (PET), or a polyetherimide (PEI).

According to yet other embodiments, where the low dielectric constant layer 470 consist essentially of a thermoplastic polymer, the thermoplastic polymer may consist essentially of a particular material. For example, the thermoplastic polymer may consist essentially of a polyvinyl chloride (PVC). According to still other embodiments, the thermoplastic polymer may consist essentially of a polyurethane (PU). According to other embodiments, the thermoplastic polymer may consist essentially of a polyaryl ether ketone (PAEK). According to other embodiments, the thermoplastic polymer may consist essentially of a polyether ether ketone (PEEK). According to other embodiments, the thermoplastic polymer may consist essentially of a polyether ketone ketone (PEKK). According to other embodiments, the thermoplastic polymer may consist essentially of a polypropylene (PP). According to other embodiments, the thermoplastic polymer may consist essentially of a polycarbonate (PC). According to still other embodiments, the thermoplastic polymer may consist essentially or a polyethersulfone (PESU). According to yet other embodiments, the thermoplastic polymer may consist essentially or a polyphenylene sulfide (PPS). According to other embodiments, the thermoplastic polymer may consist essentially or a polyamide 6 (PA6). According to still other embodiments, the thermoplastic polymer may consist essentially of a polyethylene terephthalate (PET). According to yet other embodiments, the thermoplastic polymer may consist essentially of a polyetherimide (PEI). According to other embodiments, the thermoplastic polymer may consist essentially of any combination of a polyvinyl chloride (PVC), a polyurethane (PU), a polyaryl ether ketone (PAEK), a polyether ether ketone (PEEK), a polyether ketone ketone (PEKK), a polypropylene (PP), a polycarbonate (PC), a polyethersulfone (PESU), a polyphenylene sulfide (PPS), a polyamide 6 (PA6), a polyethylene terephthalate (PET), or a polyetherimide (PEI).

According to yet other embodiments, where the low dielectric constant layer 470 includes a thermoset polymer, the thermoset polymer may include a particular material. For example, the thermoset polymer may include an aramid (e.g., Nomex). According to still other embodiments, the thermoset polymer may include a resin. According to other embodiments, the thermoset polymer may include an epoxy resin. According to other embodiments, the thermoset polymer may include a cyanate ester resin. According to other embodiments, the thermoset polymer may include a phenolic resin. According to other embodiments, the thermoset polymer may include a polyester resin. According to yet other embodiments, the thermoset polymer may include a thermoset polyurethane. According to other embodiments, the thermoset polymer may include any combination of an aramid (e.g., Nomex), a resin, an epoxy resin, a cyanate ester resin, a phenolic resin, a polyester resin, or a thermoset polyurethane.

According to yet other embodiments, where the low dielectric constant layer 470 consist essentially of a thermoset polymer, the thermoset polymer may consist essentially of a particular material. For example, the thermoset polymer may consist essentially of an aramid (e.g., Nomex). According to still other embodiments, the thermoset polymer may consist essentially of a resin. According to other embodiments, the thermoset polymer may consist essentially of an epoxy resin. According to other embodiments, the thermoset polymer may consist essentially of a cyanate ester resin. According to other embodiments, the thermoset polymer may consist essentially of a phenolic resin. According to other embodiments, the thermoset polymer may consist essentially of a polyester resin. According to yet other embodiments, the thermoset polymer may consist essentially of a thermoset polyurethane. According to other embodiments, the thermoset polymer may consist essentially of any combination of an aramid (e.g., Nomex), a resin, an epoxy resin, a cyanate ester resin, a phenolic resin, a polyester resin, or a thermoset polyurethane.

According to yet other embodiments, the low dielectric constant layer 470 may have a particular structure. For example, the low dielectric constant layer 470 may have a fully dense structure. According to yet other embodiments, the low dielectric constant layer 470 may have a foam structure. According to still other embodiments, the low dielectric constant layer 470 may have an open foam structure. According to other embodiments, the low dielectric constant layer 470 may have a closed foam cell structure. According to yet other embodiments, the low dielectric constant layer 470 may have a cellular structure. According to other embodiments, the low dielectric constant layer 470 may have a honeycomb cellular structure. According to yet other embodiments, the low dielectric constant layer 470 may have a gyroid cellular structure. According to still other embodiments, the low dielectric constant layer 470 may have a lattice structure. According to other embodiments the low dielectric constant layer 470 may have any combination of open cell foam structure, a closed foam cell structure, a cellular structure, a honeycomb cellular structure, a gyroid cellular structure, or a lattice structure.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A radome structure comprising: a first syntactic foam layer, a multilayer tuning component overlying the first syntactic foam layer and comprising a first tuning sublayer and a second tuning sublayer overlying the first tuning sublayer, a structural laminate core overlying and in contact with the multilayer tuning component, and a second syntactic foam layer overlying the structural laminate core, wherein the first tuning sublayer comprises a dielectric constant (Dₖ₁) of at least about 1 and not greater than about 3, wherein the second tuning sublayer comprises a dielectric constant (Dₖ₂) of at least about 1 and not greater than about 3, and wherein the multilayer tuning component comprises an average dielectric constant

$$\frac{{D}_{k 1} + {D}_{k 2}}{2}$$

of at least about 2 and not greater than about 3, where Dₖ₁ is the dielectric constant of the first tuning sublayer, and Dₖ₂ is the dielectric constant of the second tuning sublayer.

Embodiment 2. A radome structure comprising: a first syntactic foam layer, a multilayer tuning component overlying the first syntactic foam layer and comprising a first tuning sublayer and a second tuning sublayer overlying the first tuning sublayer, a structural laminate core overlying and in contact with the multilayer tuning component, and a second syntactic foam layer overlying the structural laminate core, wherein the first tuning sublayer comprises a thermoplastic polymer, a thermoset polymer, or any combination thereof, and wherein the multilayer tuning component comprises an average dielectric constant

$$\frac{{D}_{k 1} + {D}_{k 2}}{2}$$

of at least about 2 and not greater than about 3, where Dₖ₁ is a dielectric constant of the first tuning sublayer, and Dₖ₂ is a dielectric constant of the second tuning sublayer.

Embodiment 3. The radome structure of any one of embodiments 1 and 2, wherein the first tuning sublayer comprises a thickness of at least about 0.5 mm.

Embodiment 4. The radome structure of any one of embodiments 1 and 2, wherein the first tuning sublayer comprises a thickness of at not greater than about 2.0 mm.

Embodiment 5. The radome structure of embodiment 2, wherein the first tuning sublayer comprises a dielectric constant of at least about 1.

Embodiment 6. The radome structure of embodiment 2, wherein the first tuning sublayer comprises a dielectric constant of not greater than about 3.

Embodiment 7. The radome structure of embodiment 1, wherein the first tuning sublayer comprises a thermoplastic polymer, a thermoset polymer, or any combination thereof.

Embodiment 8. The radome structure of any one of embodiments 2 and 7, wherein the thermoplastic polymer comprises a polyvinyl chloride (PVC), a polyurethane (PU), a polyaryl ether ketone (PAEK), a polyether ether ketone (PEEK), a polyether ketone ketone (PEKK), a polypropylene (PP), a polycarbonate (PC), or any combination thereof.

Embodiment 9. The radome structure of any one of embodiments 2 and 7, wherein the thermoset polymer comprises an aramid (e.g., Nomex), a resin, an epoxy resin, a cyanate ester resin, a phenolic resin, a polyester resin, a thermoset polyurethane, or any combination thereof.

Embodiment 10. The radome structure of any one of embodiments 2 and 7, wherein the first tuning sublayer comprises a fully dense structure, a foam structure, an open cell foam structure, a closed foam cell structure, a cellular structure, a honeycomb cellular structure, a gyroid cellular structure, a lattice structure, or any combination thereof.

Embodiment 11. The radome structure of any one of embodiments 1 and 2, wherein the second tuning sublayer comprises a thickness of at least about 0.5 mm.

Embodiment 12. The radome structure of any one of embodiments 1 and 2, wherein the second tuning sublayer comprises a thickness of at not greater than about 2.0 mm.

Embodiment 13. The radome structure of embodiment 2, wherein the second tuning sublayer comprises a dielectric constant of at least about 1.

Embodiment 14. The radome structure of embodiment 2, wherein the second tuning sublayer comprises a dielectric constant of not greater than about 3.

Embodiment 15. The radome structure of any one of embodiments 1 and 2, wherein the second tuning sublayer comprises a thermoplastic polymer, a thermoset polymer, or any combination thereof.

Embodiment 16. The radome structure of embodiment 15, wherein the thermoplastic polymer comprises a polyvinyl chloride (PVC), a polyurethane (PU), a polyaryl ether ketone (PAEK), a polyether ether ketone (PEEK), a polyether ketone ketone (PEKK), a polypropylene (PP), a polycarbonate (PC), or any combination thereof.

Embodiment 17. The radome structure of embodiment 15, wherein the thermoset polymer comprises an aramid (e.g., Nomex), a resin, an epoxy, a cyanate ester, a phenolic, a polyester, a thermoset polyurethane, or any combination thereof.

Embodiment 18. The radome structure of embodiment 15, wherein the second tuning sublayer comprises a fully dense structure, a foam structure, an open cell foam structure, a closed foam cell structure, a syntactic foam structure, a cellular structure, a honeycomb cellular structure, a gyroid cellular structure, a lattice structure, or any combination thereof.

Embodiment 19. The radome structure of any one of embodiments 1 and 2, wherein the multilayer tuning component comprises a thickness of at least about 0.5 mm.

Embodiment 20. The radome structure of any one of embodiments 1 and 2, wherein the multilayer tuning component comprises a thickness of at not greater than about 3.0 mm.

Embodiment 21. The radome structure of any one of embodiments 1 and 2, wherein the first syntactic foam layer comprises a thickness of at least about 0.5 mm.

Embodiment 22. The radome structure of any one of embodiments 1 and 2, wherein the first syntactic foam layer comprises a thickness of at not greater than about 3.0 mm.

Embodiment 23. The radome structure of any one of embodiments 1 and 2, wherein the first syntactic foam layer comprises a dielectric constant of at least about 1.3.

Embodiment 24. The radome structure of any one of embodiments 1 and 2, wherein the first syntactic foam layer comprises a dielectric constant of not greater than about 2.0.

Embodiment 25. The radome structure of any one of embodiments 1 and 2, wherein the second syntactic foam layer comprises a thickness of at least about 0.5 mm.

Embodiment 26. The radome structure of any one of embodiments 1 and 2, wherein the second syntactic foam layer comprises a thickness of at not greater than about 3.0 mm.

Embodiment 27. The radome structure of any one of embodiments 1 and 2, wherein the second syntactic foam layer comprises a dielectric constant of at least about 1.3.

Embodiment 28. The radome structure of any one of embodiments 1 and 2, wherein the second syntactic foam layer comprises a dielectric constant of not greater than about 2.0.

Embodiment 29. The radome structure of any one of embodiments 1 and 2, wherein the structural laminate core comprises a thickness of at least about 0.06 inches.

Embodiment 30. The radome structure of any one of embodiments 1 and 2, wherein the structural laminate core comprises a thickness of at not greater than about 0.25 inches.

Embodiment 31. The radome structure of any one of embodiments 1 and 2, wherein the structural laminate core comprises a dielectric constant of at least about 4.0.

Embodiment 32. The radome structure of any one of embodiments 1 and 2, wherein the structural laminate core comprises a dielectric constant of not greater than about 5.0.

Embodiment 33. The radome structure of any one of embodiments 1 and 2, wherein the structural laminate core comprises a glass fiber composite material.

Embodiment 34. The radome structure of embodiment 33, wherein the glass fiber composite material comprises a glass-epoxy, a glass-cyanate ester, a thermoplastic material, glass-phenolic resin, glass fibers with a thermoplastic matrix such as polycarbonate, polypropylene, or polyethylene.

Embodiment 35. The radome structure of any one of embodiments 1 and 2, wherein the radome structure further comprises a first protective layer underlying the first syntactic foam layer.

Embodiment 36. The radome structure of embodiment 35, wherein the first protective layer comprises a thickness of at least about 0.05 mm.

Embodiment 37. The radome structure of embodiment 35, wherein the first protective layer comprises a thickness of at not greater than about 0.40 mm.

Embodiment 38. The radome structure of embodiment 35, wherein the first protective layer comprises a dielectric constant of at least about 2.5.

Embodiment 39. The radome structure of embodiment 35, wherein the first protective layer comprises a dielectric constant of not greater than about 3.0.

Embodiment 40. The radome structure of embodiment 35, wherein the first protective layer comprises an epoxy resin, a cyanate ester resin, a phenolic resin, a polyester resin, a thermoset polyurethane, a thermoplastic polymer, a polyvinyl chloride (PVC), a polyurethane (PU), a polyaryl ether ketone (PAEK), a polyether ether ketone (PEEK), a polyether ketone ketone (PEKK), a polypropylene (PP), a polycarbonate (PC), a polyethersulfone (PESU), a polyphenylene sulfide (PPS), a polyamide 6 (PA6), a polyethylene terephthalate (PET), or a polyetherimide (PEI), or any combination thereof.

Embodiment 41. The radome structure of any one of embodiments 1 and 2, wherein the radome structure further comprises a second protective layer overlying the second syntactic foam layer.

Embodiment 42. The radome structure of embodiment 41, wherein the second protective layer comprises a thickness of at least about 0.05 mm.

Embodiment 43. The radome structure of embodiment 41, wherein the second protective layer comprises a thickness of not greater than about 0.80 mm.

Embodiment 44. The radome structure of embodiment 41, wherein the second protective layer comprises a dielectric constant of at least about 2.5.

Embodiment 45. The radome structure of embodiment 41, wherein the second protective layer comprises a dielectric constant of not greater than about 4.0.

Embodiment 46. The radome structure of embodiment 41, wherein the second protective layer comprises an epoxy resin, a cyanate ester resin, a phenolic resin, a polyester resin, a thermoset polyurethane, a thermoplastic polymer, a polyvinyl chloride (PVC), a polyurethane (PU), a polyaryl ether ketone (PAEK), a polyether ether ketone (PEEK), a polyether ketone ketone (PEKK), a polypropylene (PP), a polycarbonate (PC), a polyethersulfone (PESU), a polyphenylene sulfide (PPS), a polyamide 6 (PA6), a polyethylene terephthalate (PET), or a polyetherimide (PEI), or any combination thereof.

Embodiment 47. The radome structure of embodiment 41, wherein the second protective layer comprises a low dielectric constant fiber reinforced resin material.

Embodiment 48. The radome structure of embodiment 47, wherein the low dielectric constant fiber reinforced resin material comprises a quartz-epoxy, a quartz-cyanate ester, or any combination thereof.

Embodiment 49. The radome structure of embodiment 41, wherein the radome structure further comprises a low dielectric constant layer underlying the first protective layer.

Embodiment 50. The radome structure of embodiment 49, wherein the low dielectric constant layer comprises a thickness of at least about 1.0 mm.

Embodiment 51. The radome structure of embodiment 49, wherein the low dielectric constant layer comprises a thickness of at not greater than about 3.0 mm.

Embodiment 52. The radome structure of embodiment 49, wherein the low dielectric constant layer comprises a dielectric constant of at least about 1.0.

Embodiment 53. The radome structure of embodiment 49, wherein the low dielectric constant layer comprises a dielectric constant of not greater than about 1.6.

Embodiment 54. The radome structure of embodiment 49, wherein the low dielectric constant layer comprises a thermoplastic polymer, a thermoset polymer, or any combination thereof.

Embodiment 55. The radome structure of embodiment 54, wherein the thermoplastic polymer comprises a polyvinyl chloride (PVC), a polyurethane (PU), a polyaryl ether ketone (PAEK), a polyether ether ketone (PEEK), a polyether ketone ketone (PEKK), a polypropylene (PP), a polycarbonate (PC), or any combination thereof.

Embodiment 56. The radome structure of embodiment 54, wherein the thermoset polymer comprises an aramid (e.g., Nomex), a resin, an epoxy, a cyanate ester, a phenolic, a polyester, a thermoset polyurethane, or any combination thereof.

Embodiment 57. The radome structure of embodiment 54, wherein the first tuning sublayer comprises a foam structure, an open cell foam structure, a closed foam cell structure, a cellular structure, a honeycomb cellular structure, a gyroid cellular structure, a lattice structure, or any combination thereof.

Embodiment 58. The radome structure of any one of embodiments 1 and 2, wherein the radome structure comprises a thickness of at least about 6.0 mm.

Embodiment 59. The radome structure of any one of embodiments 1 and 2, wherein the radome structure comprises a thickness of not greater than about 14.0 mm.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A radome structure comprising:
a first syntactic foam layer,
a multilayer tuning component overlying the first syntactic foam layer and comprising a first tuning sublayer and a second tuning sublayer overlying the first tuning sublayer,
a structural laminate core overlying and in contact with the multilayer tuning component, and
a second syntactic foam layer overlying the structural laminate core,
wherein the first tuning sublayer comprises a dielectric constant (Dₖ₁) of at least about 1 and not greater than about 3,
wherein the second tuning sublayer comprises a dielectric constant (Dₖ₂) of at least about 1 and not greater than about 3, and
wherein the multilayer tuning component comprises an average dielectric constant
$$\frac{{D}_{k 1} + {D}_{k 2}}{2}$$
of at least about 2 and not greater than about 3, where Dₖ₁ is the dielectric constant of the first tuning sublayer, and Dₖ₂ is the dielectric constant of the second tuning sublayer.

2. The radome structure of claim 1, wherein the first tuning sublayer comprises a thermoplastic polymer, a thermoset polymer, or any combination thereof.

3. The radome structure of claim 1, wherein the second tuning sublayer comprises a thermoplastic polymer, a thermoset polymer, or any combination thereof.

4. The radome structure of claim 1, wherein the first syntactic foam layer comprises a dielectric constant of at least about 1.3 and not greater than about 2.0.

5. The radome structure of claim 1, wherein the second syntactic foam layer comprises a dielectric constant of at least about 1.3 and not greater than about 2.0.

6. The radome structure of claim 1, wherein the structural laminate core comprises a dielectric constant of at least about 4.0 and not greater than about 5.0.

7. The radome structure of claim 1, wherein the structural laminate core comprises a glass fiber composite material.

8. The radome structure of claim 1, wherein the radome structure further comprises a first protective layer underlying the first syntactic foam layer.

9. The radome structure of claim 8, wherein the first protective layer comprises a dielectric constant of at least about 2.5 and not greater than about 3.0.

10. The radome structure of claim 8, wherein the first protective layer comprises an epoxy resin, a cyanate ester resin, a phenolic resin, a polyester resin, a thermoset polyurethane, a thermoplastic polymer, a polyvinyl chloride (PVC), a polyurethane (PU), a polyaryl ether ketone (PAEK), a polyether ether ketone (PEEK), a polyether ketone ketone (PEKK), a polypropylene (PP), a polycarbonate (PC), a polyethersulfone (PESU), a polyphenylene sulfide (PPS), a polyamide 6 (PA6), a polyethylene terephthalate (PET), or a polyetherimide (PEI), or any combination thereof.

11. A radome structure comprising:
a first syntactic foam layer,
a multilayer tuning component overlying the first syntactic foam layer and comprising a first tuning sublayer and a second tuning sublayer overlying the first tuning sublayer,
a structural laminate core overlying and in contact with the multilayer tuning component, and
a second syntactic foam layer overlying the structural laminate core,
wherein the first tuning sublayer comprises a thermoplastic polymer, a thermoset polymer, or any combination thereof, and
wherein the multilayer tuning component comprises an average dielectric constant
$$\frac{{D}_{k 1} + {D}_{k 2}}{2}$$
of at least about 2 and not greater than about 3, where Dₖ₁ is a dielectric constant of the first tuning sublayer, and Dₖ₂ is a dielectric constant of the second tuning sublayer.

12. The radome structure of claim 2, wherein the first tuning sublayer comprises a dielectric constant of at least about 1 and not greater than about 3.

13. The radome structure of claim 2, wherein the first tuning sublayer comprises a fully dense structure, a foam structure, an open cell foam structure, a closed foam cell structure, a cellular structure, a honeycomb cellular structure, a gyroid cellular structure, a lattice structure, or any combination thereof.

14. The radome structure of claim 2, wherein the second tuning sublayer comprises a dielectric constant of at least about 1 and not greater than about 3.

15. The radome structure of claim 2, wherein the second tuning sublayer comprises a thermoplastic polymer, a thermoset polymer, or any combination thereof.

16. The radome structure of claim 2, wherein the first syntactic foam layer comprises a dielectric constant of at least about 1.3 and not greater than about 2.0.

17. The radome structure of claim 2, wherein the second syntactic foam layer comprises a dielectric constant of at least about 1.3 and not greater than about 2.0.

18. The radome structure of claim 2, wherein the structural laminate core comprises a dielectric constant of at least about 4.0 and not greater than about 5.0.

19. The radome structure of claim 2, wherein the structural laminate core comprises a glass fiber composite material.

20. The radome structure of claim 2, wherein the radome structure further comprises a first protective layer underlying the first syntactic foam layer.
